(19) United States
(12) Patent Application Publication
(10) Pub. No.: US 2007/0040677 A1
(43) Pub. Date: Feb. 22, 2007

(54) Detecting cargo status and load activity

(76) Inventor: Herbert W. Blair JR., Carrollton, TX (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/205,778

(22) Filed: Aug. 17, 2005

(51) Int. Cl. G08B 13/14

(52) U.S. Cl. 340/568.1

(57) ABSTRACT

A cargo detection unit that detect the status of cargo and loading activity within a container. The device transmits microwave radio frequency energy pulses and detects reflections from cargo. Similar to the operation of a radar, the reflected pulses are then analyzed to determine (a) the presence of cargo, such as by comparing the reflected pulses against stored empty containers signature signals and/or (b) detecting a Doppler effect, as caused by loading and/or unloading cargo from the container. The device may use standard radar signal processing techniques, i.e., a digital signal processor, to generate and analyze the reflected pulses cargo status. Activity reports can be forwarded to a cargo tracking unit such as one that uses a wireless mobile telephone communication network to report cargo status to a central location.

### BACKGROUND OF THE INVENTION

Centralized systems for the tracking of vehicles and the assets that they are carry have been around since perhaps the first radios were placed in taxi cabs and tractor trailers in the 1930's. With the widespread availability of microcomputers and cellular mobile telephone technology, automated systems for asset tracking are now quite cost effective. Initially, this technology was primarily intended for exception management, that is, determining when a shipment is not expected to reach its intended destination.

More recently, this technology has been found to be quite useful in other ways. For example, some systems can automatically schedule the assignment of assets so that overall fleet utilization is optimized. Knowing the precise location and status of cargo trailers has proven to be extremely valuable to such fleet management systems.

A key piece of information needed in optimizing fleet utilization is to know when and where a trailer is loaded or unloaded. Until recently, fleet operations relied on the accuracy of reports from drivers for this information. More recent systems make use of automated sensors such as door open/closed and/or weight sensors to detect when a trailer is loaded or unloaded, and by how much.

However, each of these cargo detection methods may be inaccurate. Human drivers are prone to making mistakes, or perhaps to even exaggerate the truth in order to hide route irregularities. Doors sensors alone do not provide information about whether a trailer is full. And even weight sensors cannot actually estimate whether or not there is still room in the trailer for additional cargo.

In an attempt to more accurately estimate whether a trailer is empty or full, some have deployed ultrasonic transducers. In this approach an ultrasonic sensor is mounted in one location within the trailer, typically at the head end. The ultrasonic sensor sends out an acoustic signal that bounces off objects within its range. By analyzing the signals that return, an estimate of empty volume of the trailer can be made.

However, even ultrasonic sensors have their shortcomings. One shortcoming is the non-standardized, somewhat obtuse interior dimensions of a typical cargo trailer. In the United States, a standard trailer has internal dimensions of roughly 53′ long but only 8′ wide and 9′ tall. When dealing with ultrasonic signals in a closed space with primarily metal walls, the reflections are quite numerous. The best location for the placement of such an ultrasonic sensor is therefore not immediately apparent. Furthermore, processing of return signals must be sufficiently sensitive to detect the presence of cargo within the trailer while at the same time remaining immune to false returns generated by reflections from the metal floor, ceilings, and walls.

Some have proposed the use of multiple ultrasonic sensors, as in a co-pending U.S. Patent Application No. 60/400,664 filed Aug. 1, 2002 and assigned to Terion, Inc., the assignee of the present invention. With that approach, an ultrasonic detection unit can include multiple ultrasonic detectors that operate in different modes such as a short range, a long range and a proximity range mode. Operating in two or more of the modes allows the ultrasonic detection unit to provide better coverage.

### SUMMARY OF THE INVENTION

The present invention is a device that detects the presence of cargo within a container using microwave radio frequency (RF) energy. Microwave RF energy is transmitted within the container, preferably in the form of transmitted pulses. Subsequent detection of reflected RF energy pulses, similar to the operation of a radar system, is then used to determine the extent to which a load exists within the container. By furthermore detecting the Doppler effect on the reflected pulses, the device can determine movement within the container such as caused by loading and unloading activity.

In a preferred embodiment the invention generates microwave radio frequency pulses typically in a carrier range of about 10 GigaHertz (GHz). The energy is focused in both the E-plane and H-plane by a horn antenna. The pulses are generated at a power level that is suitable for covering the length of a cargo trailer or similarly shaped container. In a typical cargo trailer, output power levels in the range of about 12 dBm are sufficient to provide coverage over a range from about 53 feet away from the location of the detection unit.

The device is typically affixed at the front or rear of a trailer, near the roof. The horn antenna is angled downward to project microwave energy pulses toward the floor and rear door area of the trailer.

Return energy is measured as to amplitude and time of arrival by any suitable radar pulse detection technique. In a preferred embodiment, a Digital Signal Processor (DSP) is used to analyze the return pulses. The return pulses are detected in a microwave receiver using envelope detection techniques, amplified, filtered, and then digitized in an analog-to-digital converter (ADC). The digitized pulses are then passed to the DS. The DSP further digitally filters the return signal, and determines a range to the “targets”, that is, determines the range to any cargo loaded within the container. Range can be determined by using time of arrival calculations and/or comparing the amplitude of the return signal to one or more reference signals.

The DSP can also determine any movement within the cargo area, such as by detecting the Doppler effect on the return pulses. The detected movement can then be used to report a load/unload event in progress.

The device thus can provide cargo state information concerning the trailer including state events such as:

unloaded (the absence of something inside the cargo area);

loaded (something is inside the cargo area); and

activity (cargo is being added to or removed from the trailer).

In a preferred embodiment, the cargo detection device is connected to a trailer tracking unit such as one that uses wireless communication via a mobile telephone network to provide cargo status reports to a central location. The trailer tracking unit provides power and control signals to the cargo sensor, and receives state information therefrom. The trailer tracking unit typically also provides data processing functions via a microcomputer and other sensors such as door position sensors, Global Positioning System (GPS) location sensors and the like. The data processor within the trailer tracking device manages the operation of the cargo detection unit, which can also be remotely controlled from the central location via the cellular telephone network.

The advantage of using this invention, as compared to currently available acoustic sensors, include increased power efficiency and reduce susceptibility to temperature and humidity variations.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high level block diagram of a cargo sensor and its connection to a trailer tracking unit according to the present invention.

FIGS. 2A and 2B illustrate typical placement of the cargo sensor within a trailer.

FIG. 3 is a cross section view showing placement of the cargo sensor within a forward wall of the trailer.

FIGS. 4A and 4B are respective views of the E-plane and H-plane beam coverage.

FIGS. 5A and 5B are front and side views of a housing for the cargo sensor.

FIG. 6 is a high level block diagram of the cargo sensor electronics.

FIG. 7 is a more detailed block diagram of the electronics.

### DETAILED DESCRIPTION OF THE INVENTION

A description of preferred embodiments of the invention follows.

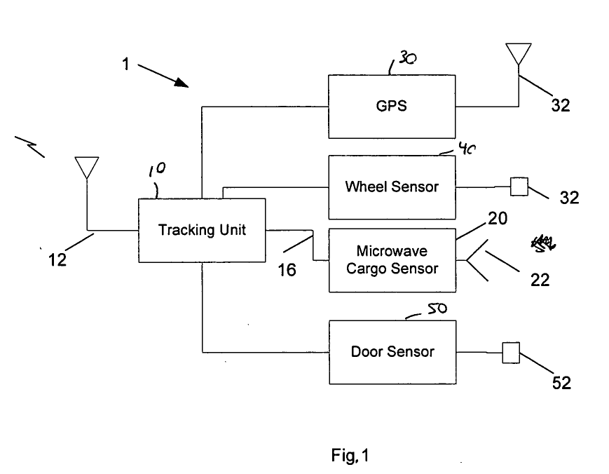

FIG. 1 illustrates the environment of a shipping container or trailer 1 that includes a mobile asset tracking system unit 10 and a cargo detection unit 20 according to the present invention. The mobile asset tracking unit 10 may, for example, be the FleetView™ product sold by Terion, Inc. of Plano, Tex. The tracking unit 10 communicates with a remote central location (not shown in the drawings) via a wireless communication network such as a cellular telephone network via cellular antenna 12 to receive commands and data, and to provide status information about the trailer 1.

The tracking unit 10 collects cargo status information from the cargo detection unit 20. As will be described in detail below, the cargo detection unit 20 uses microwave radio frequency energy to scan the interior of the trailer 1 to determine cargo status information. The cargo status information may include data indicating an empty trailer, a loaded trailer, and loading/unloading event information.

The microwave cargo detection device 20 communicates with the tracking unit 10 through any suitable data connection such as through a serial interface 16.

The tracking unit 10 also typically receives information from other sensors on the trailer 1. These may include location information provided by a Global Positioning system (GPS) receiver 30 and associated GPS antenna 32; a wheel movement sensor 40 for determining intermodal movement status of the trailer such as detected by wheel rotation transducer(s) 42; and a door open/close sensor 50 that uses door position transducer(s) 52.

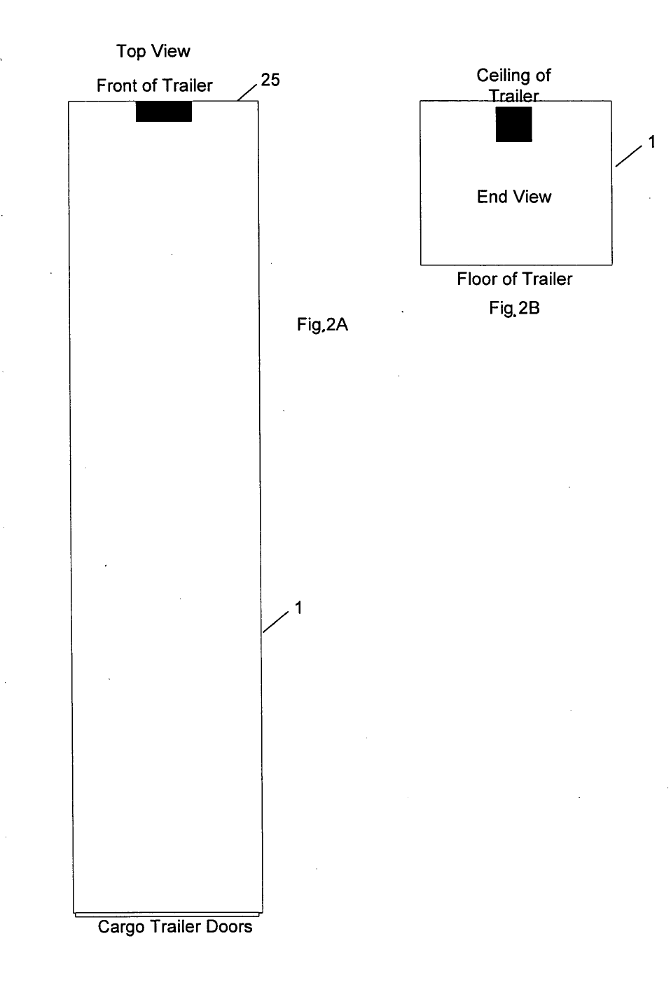

FIGS. 2A and 2B illustrate typical mounting locations for the microwave cargo sensor 20 such as may be mounted at the front end or “nose” 25 of cargo trailer 1 near the ceiling. A nose mounted microwave cargo detection unit 20 performs well for the dimensions expected of a typical cargo trailer, such as 53 feet long by 9 feet wide and 8 feet tall.

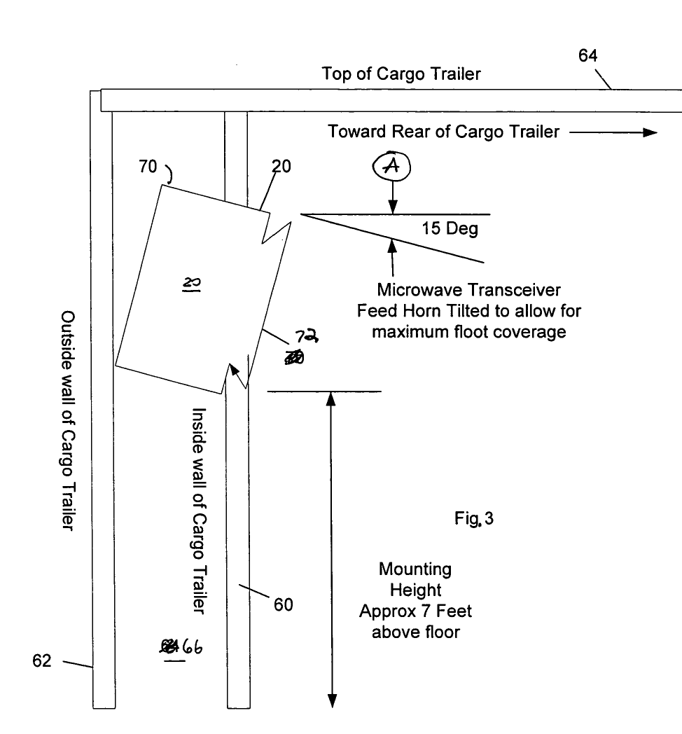

FIG. 3 is a more detailed view of the preferred mounting location of the microwave cargo sensor 20. The cargo trailer 1, shown in cross section, has outside front wall 62, inside front wall 60, and roof 64. The cargo sensor 20 is placed within the inside wall 60 of the cargo trailer 1 such that portions of its housing 70 extend within a space 66 created between the inside wall 60 and outside wall 62. A microwave transmitter feed horn portion 72 of cargo sensor 20 protrudes into the interior of trailer 1. The feed horn 72 can be tilted to allow for maximum floor coverage. In a preferred embodiment for a trailer of length 53 feet and a mounting height of about 7 feet for the cargo sensor 20, the tilt angle A is about 15 degrees downward from the horizontal.

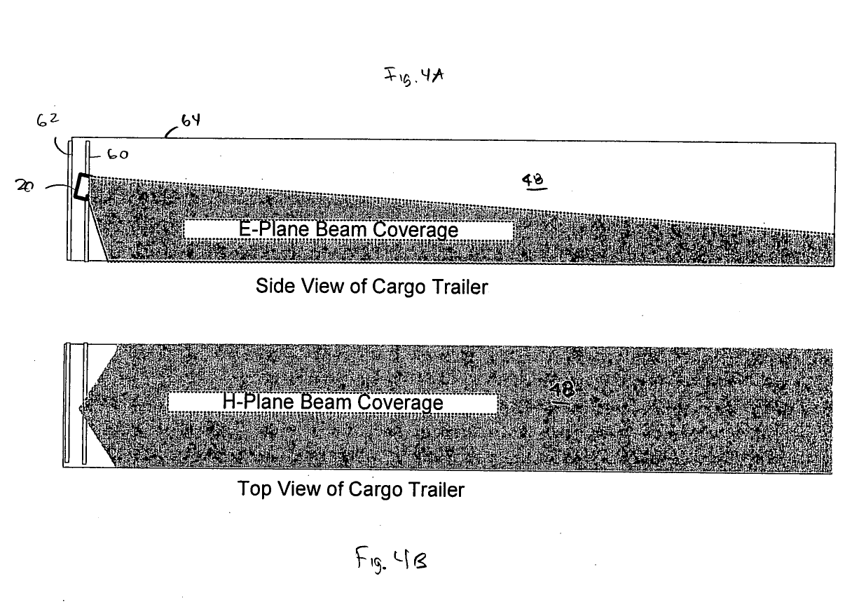

FIGS. 4A and 4B illustrate the typical coverage area of cargo sensor 20. E-plane beam coverage such as in a side view of FIG. 2A, and H-plane beam coverage as provided by top view of FIG. 2B are provided by the microwave transmitter and feed horn 72. The interior of the cargo trailer thus has good detection of nearly the entire cargo area 48, including nearly the entire floor area of the trailer 1, with a single microwave transmitter and feed horn 72. Thus it can be understood that a package resting on any part of the floor within the trailer will be detected. This is quite unlike the situation for units that use ultrasonic transducers, which typically can only provide partial and not nearly complete coverage of the interior of a trailer.

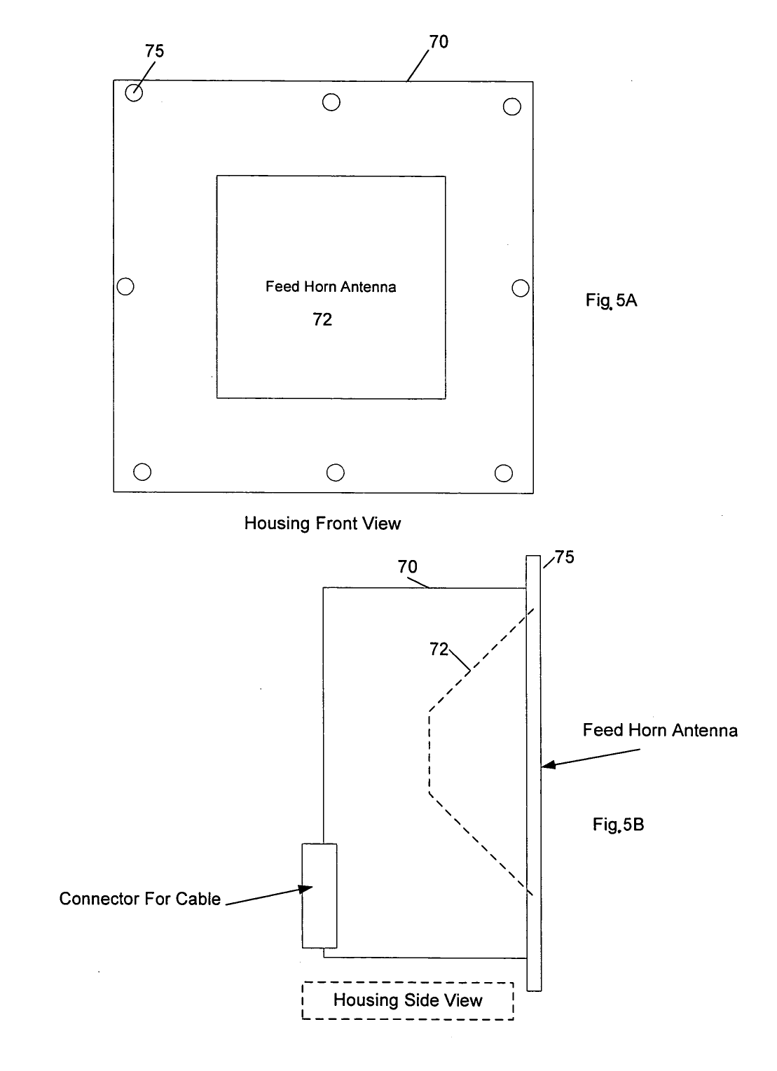

FIGS. 5A and 5B are more detailed views of the housing 70 and feed horn 72. The housing 70 typically has an outer flange 73 with multiple holes 75 used for mounting the unit 20 to the interior wall 60. Thee feed horn antenna 72 is a custom feed horn designed to achieve the desired E and H plane pattern. It is typically about 4 inches square in size. It is mounted within housing 70 with appropriate fasteners or welding.

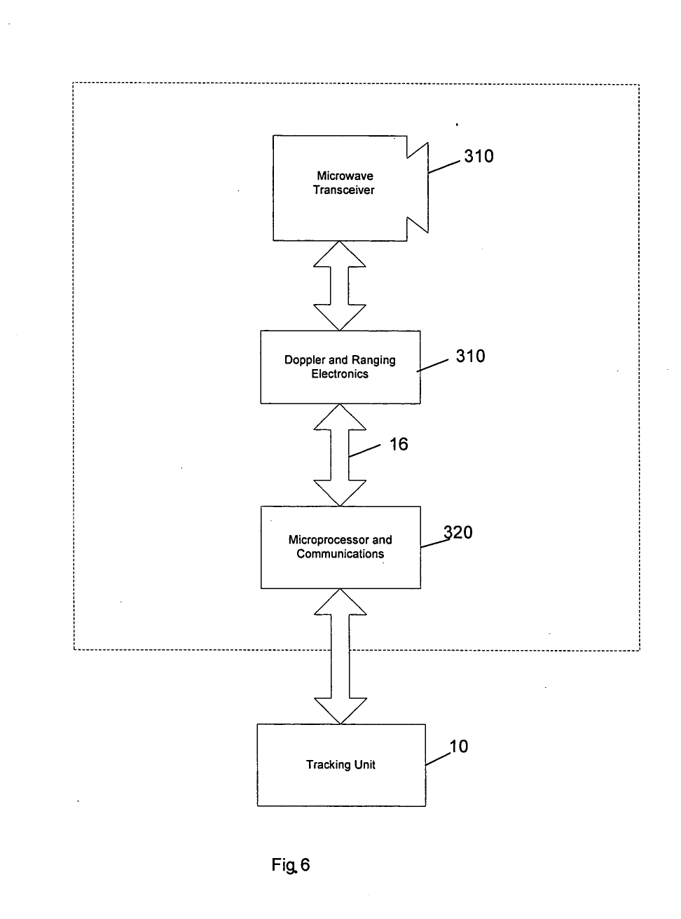

FIG. 6 is a high level block diagram of the microwave detection unit 20. The cargo sensor 20 includes a microwave transceiver 300, doppler and ranging electronics 310, microprocessor and communications circuits 320, and the aforementioned interface 16 to the tracking control unit 10.

In operation, microwave transceiver 300 senses the presence of cargo by generating microwave RF pulses and aiming them within cargo area 48. The presence of any item within the cargo area 48 generates one or more reflected RF pulses as a return signal.

The return signal is then operated on by the Doppler and ranging electronics 310. A Digital Signal Processor (DSP) within the electronics 310 compares the return signal to stored signature signals, such a GS an empty container signature signal. If there is a sufficient match, then an empty trailer condition is reported; otherwise a loaded status is reported.

Other conditions of the return signal, such as whether there is a Doppler shift on it, are made detected. If there is a Doppler shift detected, then there is movement within the trailer and a loading/unloading status is reported.

The microprocessor 320 then communicates the status information to the tracking unit 10.

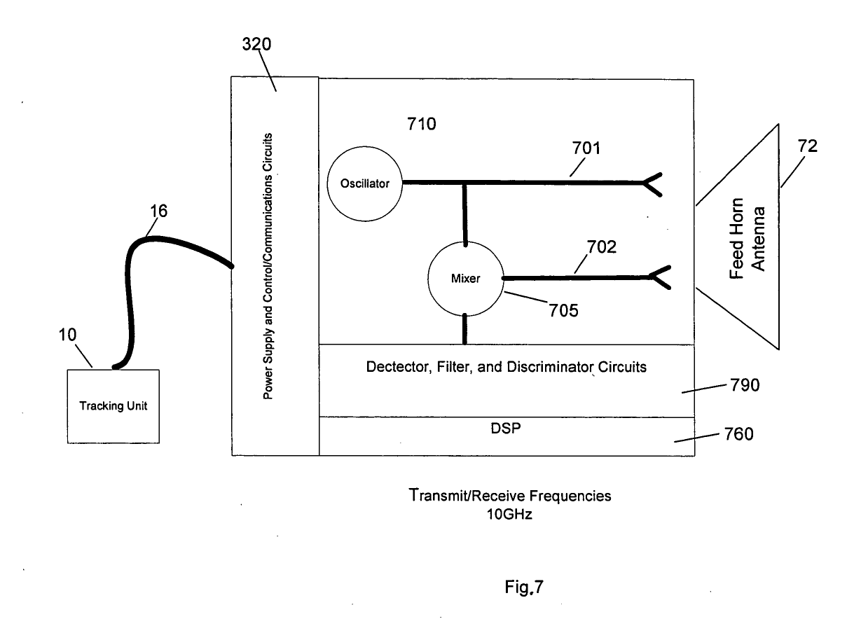

FIG. 7 is a block diagram of the electronics of the microwave cargo sensor. These include the feed horn antenna 72 having both transmit 701 and receive 702 feed connections, and microwave radio frequency (RF) signal processing circuitry including a mixer 705 and oscillator 710. The oscillator 710 operates in typical duplex radar mode to generate a series of one or more microwave RF pulses that are fed to transmitter feed 701, and then mixer 705 detects return reflections. Typical radar pulse detection, filter and discriminator circuits 750, that are well known in the radar art, provide an indication of any return signal to the DSP 760. In addition, power supply and communication circuitry 770 are included.

More particularly, in a preferred embodiment, the oscillator 710 generates microwave radio frequency (RF) energy pulses typically at a carrier of about 10 GigaHertz (GHz). The RF energy is focused in both the E-plane and H-plane by the feed horn 72. The RF pulses are generated at a power level that is suitable for covering the length of cargo trailer 1. For the typical cargo trailer 1, output power levels in the range of about 12 dBm are sufficient to provide coverage over a range from about 53 feet away from the location of the detection unit 20.

Return energy is measured as to amplitude and time of arrival by any suitable microwave receiver intended for radar pulse detection, filtering and discrimination circuits 750. For example, the return pulses may be detected using envelope detection techniques, amplified, filtered, and then digitized in an analog-to-digital converter (ADC) by circuits 750.

In a preferred embodiment, the Digital Signal Processor (DSP) 760 is then used to analyze the return pulses. The DSP further digitally filters return signal, and determines a range to the “targets”, that is, determines the range to any cargo loaded within the container. Range determination is made based on time of arrival calculations and comparing the amplitude of the return signal to one or more reference signals.

One such reference signal can be an empty signature reference signal. If there is insufficient match between the return signal and the empty reference signal, the DSP can report that the trailer 1 has cargo loaded within it. If there is a sufficient match, then DSP can report on empty status.

The DSP 760 can also determine movement within the cargo area, such as by detecting the Doppler effect on the return pulses using known techniques.

The device 20 thus can provide cargo state information concerning the trailer including state events such as:

loaded (something is inside the cargo area)

unloaded (the absence of something inside the cargo area); and

activity (cargo is being added to or removed from the trailer).

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for detecting presence of cargo within a container comprising:
transmitting microwave radio frequency (RF) energy pulses within the container from a defined location;
detecting reflected RF energy pulses at the defined location, to generate a return signal;
comparing the return signal to a reference signal, to determine whether cargo is present within the container.

2. A method as in claim 1 additionally comprising:
detecting a Doppler effect on the reflected RF energy pulses; and
in response to the presence thereof, determining there is movement within the container as caused by cargo loading and/or unloading activity.

3. A method as in claim 1 wherein the RF energy pulses are at a carrier frequency of about 10 GigaHertz (GHz).

4. A method as in claim 1 wherein the RF energy pulses are focused in both an E-plane and H-plane.

5. A method as in claim 1 wherein the RF energy pulses are generated at an output power level that is suitable for covering the length of the cargo container.

6. A method as in claim 5 wherein the output power level is about 12 dBm.

7. A method as in claim 1 wherein the RF energy pulses are transmitted by a horn antenna angled downward to project the RF energy pulses toward a floor area of the container.

8. A method as in claim 1 wherein the reflected RF energy pulses are further subjected to a range determination based on a time of arrival and/or amplitude detection.

9. A method as in claim 2 additionally comprising:
reporting a cargo state from the result of comparing the return signal to a release signal and from the result of detecting a Doppler effect, the reported cargo state being selected from one of
a loaded state, indicating an object is inside the cargo area;
an unloaded state, indicating the absence of objects inside the cargo area; and
activity, indicating that cargo is being added to or removed from the cargo area.

10. A method as in claim 9 additionally comprising:
forwarding the cargo state information to a central location via a wireless data network.
